(19) United States
(12) Patent Application Publication
(10) Pub. No.: US 2019/0143468 A1
(43) Pub. Date: May 16, 2019

(54) SYSTEM FOR ADJUSTING A FIXTURE RELATIVE TO A WORKPIECE

(71) Applicant: Ford Motor Company, Dearborn, MI (US)

(72) Inventors: Michael Allen Schmitz, Fowlerville, MI (US); Larry Fisher Adams, Maysville, KY (US)

(21) Appl. No.: 15/814,944

(22) Filed: Nov. 16, 2017

(51) Int. Cl. B23Q 17/00; B25B 5/16; G01L 5/00

(52) U.S. Cl. CPC B23Q 17/005; G01L 5/009; G01L 5/0042; B25B 5/163

(57) ABSTRACT

A fixture clamp adjustment system includes a test workpiece and an alignment block. The test workpiece has a load cell and is configured to nest upon a fixture that has a clamp such that the load cell aligns with the clamp when open and such that the clamp contacts the load cell when closed. The alignment block is configured to couple with the clamp and engage the test workpiece when the clamp is closed to maintain clamp and load cell alignment.

### TECHNICAL FIELD

The present disclosure relates to machine tool fixtures utilized for positioning a manufactured component or workpiece during manufacturing processes.

### BACKGROUND

Machine tool fixtures or pallets may be utilized to position a manufactured component or workpiece during a machining or assembly process. Machine tool fixtures or pallets may also be utilized to transport manufactured components or workpieces along a conveyor between work stations of a machining or assembly line.

### SUMMARY

A method includes providing a fixture having a clamp that is configured to secure a workpiece to the fixture, disposing a test workpiece on the fixture such that a load cell located on the test workpiece aligns with the clamp, closing the clamp to contact the load cell, and adjusting an applied torque to the clamp until an applied force on the load cell is within a predetermined range.

A method includes providing a fixture having a clamp that includes a gripping pad rotatably secured thereto, securing an alignment block to the clamp that engages the gripping pad to prevent rotation thereof, disposing a test workpiece that includes a load cell on the fixture, closing the clamp such that the gripping pad contacts the load cell, and adjusting an applied force between the clamp and load cell to within a predetermined range.

A fixture clamp adjustment system includes a test workpiece and an alignment block. The test workpiece has a load cell and is configured to nest upon a fixture that has a clamp such that the load cell aligns with the clamp when open and such that the clamp contacts the load cell when closed. The alignment block is configured to couple with the clamp and maintain clamp and load cell alignment upon closing the clamp.

### BRIEF DESCRIPTION OF THE DRAWINGS

FIG. 1 is an upper perspective view of a fixture having clamps and a workpiece disposed on the fixture;

FIG. 2 is a lower perspective view of the fixture illustrating power tools configured to apply torque to the clamps;

FIG. 3 is a partial upper perspective view of the fixture and a test workpiece disposed in the fixture;

FIG. 4 is a partial upper perspective view of the workpiece illustrating alignment blocks engaging the test workpiece; and

FIG. 5 is a flowchart illustrating a method for adjusting the parameters of a fixture.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

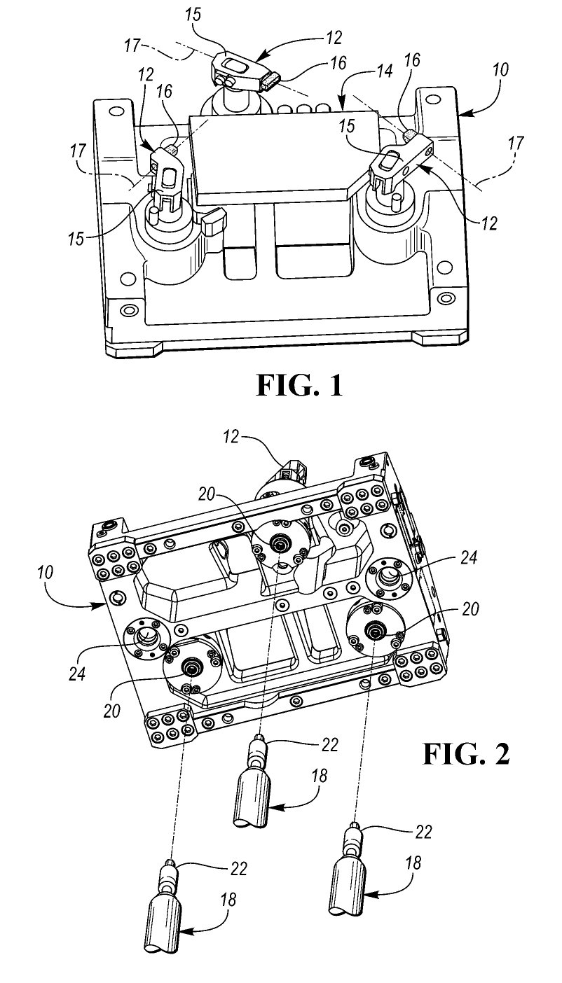

Referring to FIG. 1, an upper perspective view of a fixture 10 having clamps 12 and a workpiece 14 disposed or nesting on the fixture 10 is illustrated. The fixture 10 may be configured to position the workpiece 14 (which may also be referred to as a manufactured component) during a machining or assembly process. More specifically, the fixture 10 may include locating features, such as locating pads or locating pins (not shown), that are configured to the position and align the workpiece 14 in the correct location on the fixture 10. The fixture 10 may be disposed on a conveyance system in order to transport the workpiece 14 between work stations of the machining or assembly line. The clamps 12 may include gripping pads 16 that are configured to contact the workpiece 14 upon engagement or closing of the clamps 12 in order to secure the workpiece 14 to the fixture 10. The gripping pads 16 may be rotatably connected to arms 15 of the clamps such that the gripping pads 16 rotate about axes 17. Once the workpiece 14 is disposed on the fixture 10, the fixture 10 and workpiece 14 may be transported via the conveyance system to a clamping station along the machining or assembly line. The clamps 12 may be swivel clamps that are configured to rotate in order to engage the workpiece 14. The clamping station may include power tools that apply torque to the clamps 12, resulting in an applied force between the gripping pads 16 and the workpiece 14, in order to prevent movement and misalignment of the workpiece 14 relative to the fixture 10.

Referring to FIG. 2, a lower perspective view of the fixture 10 is illustrated. FIG. 2 also illustrates the power tools 18 in the clamping station that are configured to apply torque to the clamps 12. Each of the clamps 12 may include a socket 20 or other rotatable feature (e.g., a fastener head) that is exposed along the bottom of the fixture 10. The power tools 18 may include tool bits 22 that engage the sockets 20 (or other rotatable features) to rotate the clamps 12. Once the clamps 12 are in contact with the workpiece 14, the power tools 18 apply torque to the clamps 12 in order to adjust the applied force between the gripping pads 16 and the workpiece 14. The fixture 10 may also include or define alignment features 24 (such as locating holes) that engage mating alignment features (such as locating pins which are not shown) at each work station of the machining or assembly line, including the clamping station. When the alignment features 24 of the fixture 10 engage the mating alignment features of a particular work station, the fixture 10 and workpiece 14 (when properly positioned or aligned in the fixture 10) become properly positioned or aligned relative to any tooling of the particular workstation that may engage either fixture 10 or the workpiece 14. For example, when the alignment features 24 of the fixture 10 engage the mating alignment features of clamping station, the tool bits 22 of the power tools 18 may become properly aligned with the sockets 20 (or other rotatable features) of the clamps 12 that are exposed along the bottom of the fixture 10.

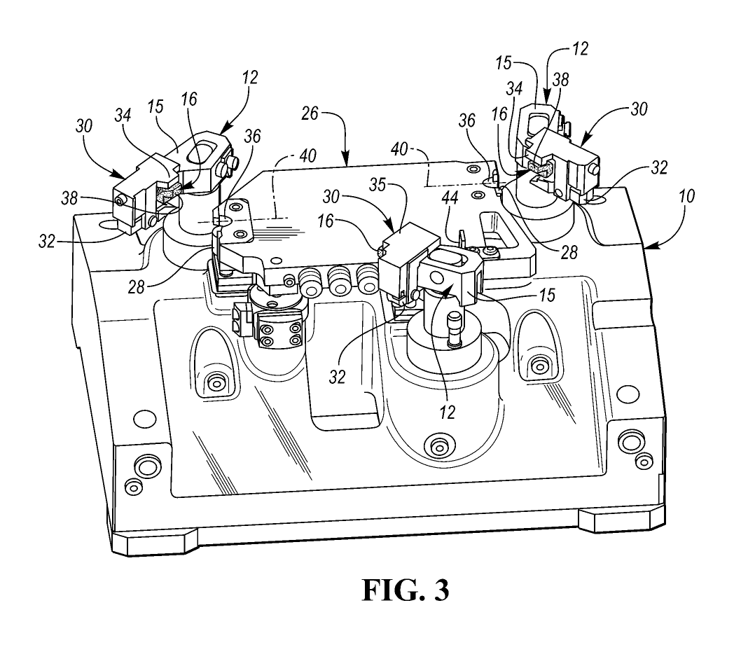

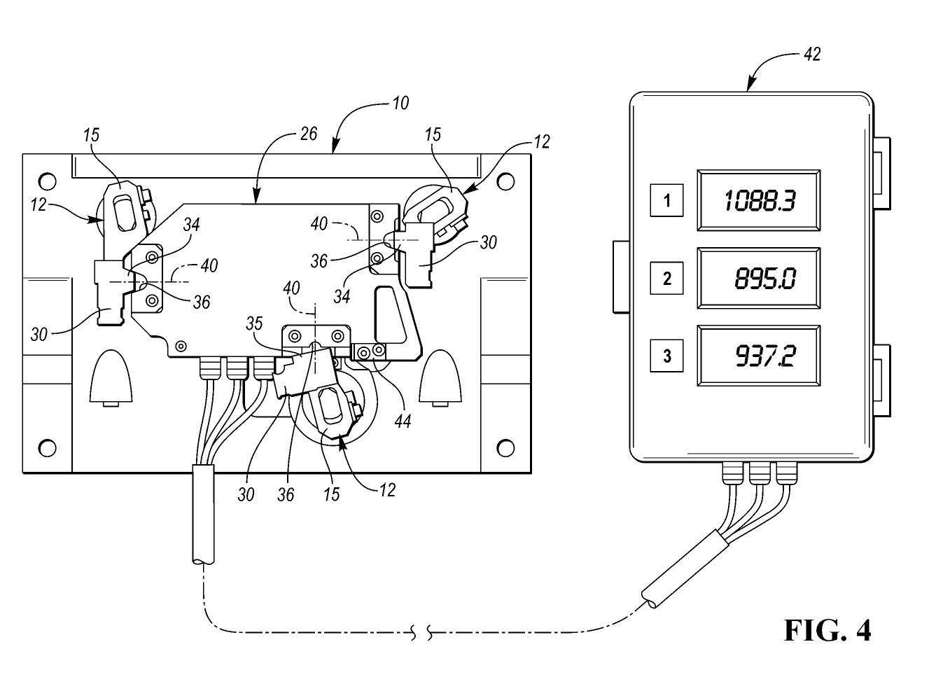

Referring to FIGS. 3 and 4, partial upper perspective views of the fixture 10 and a mock or test workpiece 26 that is disposed or nesting on the fixture 10 are illustrated. The test workpiece 26 is configured to engage the locating features (e.g., locating pads or locating pins) of the fixture 10 to position and align the test workpiece 26 in the correct location on the fixture 10. The test workpiece 26 is representative of a manufactured component (e.g., the workpiece 14) that is typically disposed on the fixture during a machining or assembly process. The test workpiece 26 is a set up tool that is utilized for adjusting the applied force between the gripping pads 16 and any workpiece that may be subsequently disposed on the fixture 10.

The test workpiece 26 includes load cells 28 that are configured to measure applied forces between the clamps 12 and the test workpiece 26. A load cell is a transducer that is used to create an electrical signal whose magnitude is directly proportional to a force being measured. Various types of load cells include hydraulic load cells, pneumatic load cells, and strain gauge load cells. Although load cells are specifically mentioned herein, it should be understood that any other type of sensors that are capable of measuring an applied force may be used in place of the load cells 28. When the test workpiece 26 is disposed on the fixture 10, each of the load cells 28 is configured to align with one of the clamps 12 when the clamp 12 is in an opened or disengaged position (i.e., not in contact with the test workpiece 26). More specifically, each of the load cells is configured to align with the gripping pads 16 of the clamps 12. Each of the clamps 12 are then configured to rotate and contact the load cell 28 that is aligned with the particular clamp 12 when the clamps 12 are transitioned to a closed or engaged positions.

Alignment blocks 30 may be configured to couple with each of the clamps 12. The alignment blocks 30 may include spring-loaded clips 32 that engage the clamps 12 to secure the alignment blocks 30 the clamps 12. The alignment blocks 30 may engage the test workpiece 26 when the clamps 12 are closed to maintain a desired clamp 12 and load cell 28 alignment. More specifically, the alignment blocks 30 may include tapered protrusions 34 that engage recesses 36 defined in the test workpiece 26 when the clamps 12 are closed to maintain the desired clamp 12 and load cell 28 alignment. The recesses 36 may also be tapered or rounded (as shown) to guide the tapered protrusions 34 during engagement. The desired clamp 12 and load cell 28 alignment may be a substantially perpendicular alignment between outer faces 38 of the gripping pads 16 and preferred loading directions 40 of the load cells 28. A more accurate reading of the force being applied to the load cell 28 may be registered by the load cell 28 when the force is applied along the preferred loading direction 40. Substantially perpendicular may refer any alignment between the outer faces 38 and the preferred loading directions 40 that ranges between 80° and 100°.

The test workpiece 26 may be electrically connected to a display screen 42. The test workpiece 26, alignment blocks 30, and display screen 42 may collectively be referred to as a fixture clamp adjustment system. The display screen 42 may be configured to display the force being applied by the clamps 12 to each of the load cells 28. More specifically, the display screen 42 may be configured to display the force being applied by the gripping pads 16 of the clamps 12 to each of the load cells 28. The force being applied by each clamp 12 to each load cell 28 may be adjusted to within a predetermined range. More specifically, the force being applied to by each clamp 12 may be adjusted by adjusting the torque being applied by the power tools 18 at the clamping station of the machining or assembly line. Once the force being applied by each clamp 12 is within the predetermined range, the control system of the clamping station may record the specific torques being applied to each clamp 12 and apply the same torque at each clamp during a subsequent operation where the fixture 10 re-enters the clamping station with a new workpiece disposed thereon.

The test workpiece 26 may also include a distinguishing feature 44 that is configured to distinguish the test workpiece 26 from an actual manufactured component (i.e., the workpiece 14). The distinguishing feature 44 is depicted as a piece of angle iron, but may be any feature that distinguishes the test workpiece 26 from an actual manufactured component. During the process where the force being applied to by each clamp 12 of the fixture 10 is adjusted, the clamping station may include a proximity sensor, camera, or other device that recognizes the distinguishing feature 44. Once the distinguishing feature 44 is recognized, the clamping station may transition to a set up mode where a computer program or human operator may adjust the torques of the power tools 18 until the force being applied by each clamp 12 to a particular load cell 28 is within the predetermined range. Also, once the distinguishing feature 44 is recognized, the clamping station may require removal of the test workpiece 26 from the fixture 10 before transporting the fixture 10 out of the clamping station in order prevent the test workpiece 26 from entering subsequent work station on the machining or assembly line, which may result in damage to the test workpiece.

The machining or assembly line may include multiple fixtures that transport workpieces between various work stations of the machining or assembly line. The clamping forces applied to individual fixtures in the clamping station may be set up utilizing the test workpiece 26 in the same manner as described above. The clamping station may then adjust the torque applied by the power tools 18 based on the specific fixture that is in the clamping station. Each fixture may include an identification tag, such as a radio frequency identification (RFID) tag, and the clamping station may include an identification tag reader, such as an RFID rag reader, so the clamping station may recognize the specific fixture that is currently in the clamping station and so that the appropriate amount of torque may be applied to each clamp of the specific fixture.

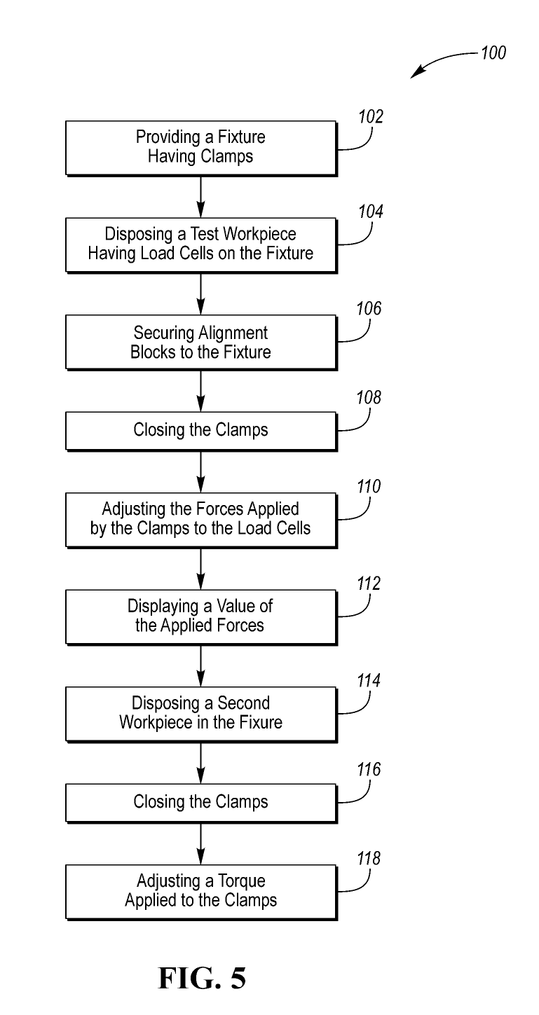

Referring to FIG. 5, a flowchart of a method 100 for adjusting the parameters of the fixture 10 is illustrated. The method 100 is initiated at block 102 where the fixture 10 is provided. The fixture 10 includes the clamps 12 that are configured to secure a manufactured component or workpiece to the fixture 10. Next, the method 100 moves on to block 104 where the test workpiece 26, that includes the load cells 28 and the defines the recesses 36, is disposed on the fixture 10 such that the loads cells 28 are aligned with the clamps 12 (or more specifically the gripping pads 16) with the clamps 12 in the opened or disengaged positions.

Once the test workpiece 26 is disposed on the fixture 10, the method 100 moves on to block 106 where the alignment blocks 30 are secured to the clamps 12. The alignment blocks 30 are configured to engage the test workpiece 26 and maintain clamp 12 and load cell alignment upon closing the clamps 12. More specifically, the tapered protrusions 34 of the alignment blocks 30 are configured to engage the recesses 36 defined in the test workpiece 26 when the clamps 12 are closed to maintain the desired gripping pad 16 and load cell 28 alignment, which may be a substantially perpendicular alignment.

Alternatively, or in addition to contacting the recesses 36, the tapered protrusions 34 may maintain a substantially perpendicular alignment between the gripping pads 16 and the load cells 28 by preventing the gripping pads 16 from rotating about the axes 17 when the clamps 12 are in the closed or engaged positions, which may lead to a misalignment of the outer faces 38 of the gripping pads 16 and the load cells 28. More specifically, the tapered protrusions 34 may be positioned directly adjacent to the gripping pads 16 when the alignment blocks 30 are secured to the clamps 12 in order prevent rotation of the gripping pads 16. If the tapered protrusions 34 are configured to maintain alignment according to this alternative function alone (i.e., the tapered protrusions 34 prevent rotation of the gripping pads 16 but do not engage the recesses 36), it is not necessary that the protrusions on the alignment block 30 be tapered protrusions. For example, see the non-tapered protrusion 35 located on the lower alignment block 30 in FIGS. 3 and 4.

After the alignment blocks 30 have been secured to the clamps 12 and the test workpiece 26 is disposed on the fixture 10, the method 100 moves on to block 108 where the clamps 12 are closed such that the clamps 12 (or more specifically the gripping pads 16) contact the load cells 28 and the alignment blocks 30 engage the test workpiece 26 (or more specifically the tapered protrusions 34 engage the recesses 36) and/or the protrusions (tapered 34 or non-tapered 35) engage the gripping pads 16 to prevent rotation of the gripping pads 16. The method 100 next moves on to block 110 where the applied forces between the clamps 12 (or more specifically the gripping pads 16) and the load cells 28 are adjusted to within a desired predetermined range. In the event that the clamps 12 are swivel clamps, the applied forces between the clamps 12 and the load cells 28 may be adjusted to within the desired predetermined range by adjusting torques applied to the clamps 12, which may be accomplished by adjusting the torque of a power tool (e.g., power tool 18). The applied forces between the clamps 12 and the load cells 28 may be displayed by the display screen 42 as illustrated in block 112. It should be understood however, that block 112 is not necessarily in chronological order that the applied forces between the clamps 12 and the load cells 28 may displayed simultaneously while any other step of the method 100 is being performed.

Once the applied forces between the clamps 12 and the load cells 28 are adjusted to within a desired predetermined range, the test workpiece 26 may be removed from the fixture and a second workpiece, which may be actual manufactured component or workpiece (e.g., workpiece 14), may be disposed on the fixture 10 at block 114. Once the second workpiece is disposed on the fixture 10, the method 100 moves on to block 116 where the clamps 12 are closed such that the clamps 12 (or more specifically the gripping pads 16) contact the second workpiece. Once the clamps 12 are closed, the method 100 moves on to block 118 where the applied forces between the clamps 12 and the second workpiece is adjusted. More specifically, at block 118 the applied forces between the clamps 12 and the second workpiece may be adjusted by adjusting the torque applied to the clamps 12 (e.g., by the power tool 18) to a value that correlates with the torque value applied at block 110 that resulted in the applied forces on the load cells 28 being adjusted to within the predetermined range.

It should be understood that the flowchart in FIG. 5 is for illustrative purposes only and that the method 100 should not be construed as limited to the flowchart in FIG. 5. Some of the steps of the method 100 may be rearranged while others may be omitted entirely.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A method comprising:
providing a fixture having a clamp configured to secure a workpiece to the fixture;
disposing a test workpiece on the fixture such that a load cell located on the test workpiece aligns with the clamp;
closing the clamp to contact the load cell; and
adjusting an applied torque to the clamp until an applied force on the load cell is within a predetermined range.

2. The method of claim 1 further comprising:
securing an alignment block to the clamp that is configured to engage the test workpiece and maintain clamp and load cell alignment upon closing the clamp.

3. The method of claim 2, wherein the alignment block is configured to engage a recess defined by the test workpiece to maintain clamp and load cell alignment upon closing the clamp.

4. The method of claim 2, wherein the alignment block maintains a substantially perpendicular clamp and load cell alignment upon closing the clamp.

5. The method of claim 1, wherein the applied torque is adjusted by a power tool.

6. The method of claim 5 further comprising:
disposing a second workpiece on the fixture;
closing the clamp to contact the second workpiece; and
adjusting the applied torque to the clamp via the power tool to a value that correlates with the applied force on the load cell being within the predetermined range.

7. The method of claim 1 further comprising the step of:
displaying a value of the applied force.

8. A method comprising:
providing a fixture having a clamp that includes a gripping pad rotatably secured thereto;
securing an alignment block to the clamp that engages the gripping pad to prevent rotation thereof;
disposing a test workpiece that includes a load cell on the fixture;
closing the clamp such that the gripping pad contacts the load cell; and
adjusting an applied force between the clamp and load cell to within a predetermined range.

9. The method of claim 8 wherein a protrusion of the alignment block engages the gripping pad to prevent rotation thereof.

10. The method of claim 9, wherein the alignment block prevents rotation of the gripping pad such that an outer face of the gripping pad maintains a substantially perpendicular alignment with the load cell upon closing the clamp.

11. The method of claim 8, wherein the clamp is a swivel clamp and the applied force is adjusted by adjusting a torque applied to the clamp via a power tool.

12. The method of claim 11 further comprising:
disposing a second workpiece on the fixture;
closing the clamp to contact the second workpiece; and
adjusting the torque applied to the clamp via the power tool to a value that correlates with the applied force between the clamp and load cell being within the predetermined range.

13. The method of claim 8 further comprising the step of:
displaying a value of the applied force.

14. A fixture clamp adjustment system comprising:
a test workpiece having a load cell and configured to nest upon a fixture having a clamp such that the load cell aligns with the clamp when open and such that the clamp contacts the load cell when closed; and
an alignment block configured to couple with the clamp and maintain clamp and load cell alignment upon closing the clamp.

15. The system of claim 14, wherein the test workpiece defines a recess, the alignment block has a tapered protrusion, and the tapered protrusion is configured to engage the recess when the clamp is closed to maintain clamp and load cell alignment.

16. The system of claim 14, wherein the alignment block maintains a substantially perpendicular clamp and load cell alignment upon closing the clamp.

17. The system of claim 14, wherein the test workpiece further includes a second load cell that aligns with a second clamp of the fixture when the test workpiece is nesting upon the fixture and the second clamp is open.

18. The system of claim 17, wherein the second clamp contacts the second load cell when closed.

19. The system of claim 14, wherein the clamp has a gripping pad rotatably secured thereto that is configured to engage the test workpiece upon closing clamp, and wherein the alignment block includes a protrusion that engages the gripping pad preventing rotation thereof such that an outer face of the gripping pad maintains a substantially perpendicular alignment with the load cell upon closing clamp.

20. The system of claim 14 further comprising a display screen configured to display a force applied to the load cell via the clamp.
